(19) United States
(12) Patent Application Publication
(10) Pub. No.: US 2023/0053085 A1
(43) Pub. Date: Feb. 16, 2023

(54) PART INSPECTION SYSTEM HAVING GENERATIVE TRAINING MODEL

(71) Applicants: TE Connectivity Services GmbH, Schaffhausen (CH); Tyco Electronics (Shanghai) Co., Ltd., Shanghai (CH); TE CONNECTIVITY INDIA PRIVATE LIMITED, Bangalore (IN)

(72) Inventors: Sonny O. Osunkwo, Harrisburg, PA (US); Lei Zhou, Shanghai (CN); Jiankun Zhou, Middletown, PA (US); Roberto Francisco-Yi Lu, Bellevue, WA (US); Dandan Zhang, Shanghai (CN); Zhonghua Xu, Shanghai (CN); Avil Saunshi, Bangalore (IN); Rajesh RK, Bangalore (IN); Andrew Riordan, Middletown, PA (US); Viraat Das, Middletown, PA (US); Krithik Rao, Middletown, PA (US); Kuruvilla Thomas Renji, Bangalore (IN); Dwivedi Jaya, Bangalore (IN)

(21) Appl. No.: 17/558,559

(22) Filed: Dec. 21, 2021

(30) Foreign Application Priority Data
Aug. 10, 2021 (CN) 202110915084.1

(51) Int. Cl. G06T 7/00; G06T 11/00; G06T 7/70; G06V 10/22; G06V 10/75; G06K 9/62; G06V 10/82; G06V 10/36; G06N 3/04

(52) U.S. Cl. CPC G06T 7/001; G06T 11/00; G06T 7/70; G06V 10/225; G06V 10/751; G06K 9/6201; G06V 10/82; G06V 10/36; G06K 9/6255; G06K 9/6256; G06N 3/0454; G06T 2207/30108; G06T 2207/20224; G06T 2207/20084; G06T 2207/20081; G06T 2210/12

(57) ABSTRACT

A part inspection system includes a vision device configured to image a part being inspected and generate a digital image of the part. The system includes a part inspection module communicatively coupled to the vision device and receives the digital image of the part as an input image. The part inspection module includes a defect detection model. The defect detection model includes a template image. The defect detection model compares the input image to the template image to identify defects. The defect detection model generates an output image. The defect detection model configured to overlay defect identifiers on the output image at the identified defect locations, if any.

### CROSS REFERENCE TO RELATED APPLICATIONS

This application claims benefit to Chinese Application No. 202110915084.1, filed 10 Aug. 2021, the subject matter of which is herein incorporated by reference in its entirety.

### BACKGROUND OF THE INVENTION

The subject matter herein relates generally to part inspection systems and methods.

With the development of image processing technologies, image processing technologies have been applied to defect detection in manufactured products. In practical applications, after one or more manufacturing steps, parts may be imaged and the images analyzed to detect for defects, such as prior to assembly of the part or shipment of the part. Some defects are difficult for known image processing systems to identify. Additionally, training of the image processing system may be difficult and time consuming. For example, training typically involves gathering many images including both good and bad images, such as images of parts that do not include defects and images of parts that do have defects, respectively. The system is trained by analyzing both the good and bad images. However, it is not uncommon to have an insufficient number of images for training, such as few bad images to train the system with the various types of defects. The algorithm used to operate the system for defect detection performs poorly. Accuracy of the inspection system is affected by poor training of the system.

A need remains for a robust part inspection system and method.

### BRIEF DESCRIPTION OF THE INVENTION

In one embodiment, a part inspection system is provided and includes a vision device configured to image a part being inspected and generate a digital image of the part. The system includes a part inspection module communicatively coupled to the vision device and receives the digital image of the part as an input image. The part inspection module includes a defect detection model. The defect detection model includes a template image. The defect detection model compares the input image to the template image to identify defects. The defect detection model generates an output image. The defect detection model configured to overlay defect identifiers on the output image at the identified defect locations, if any.

In another embodiment, a part inspection system is provided and includes a vision device configured to image a part being inspected and generate a digital image of the part. The system includes a part inspection module communicatively coupled to the vision device and receives the digital image of the part as an input image. The part inspection module has a generative neural network architecture generating a template image from training images. The part inspection module includes a defect detection model receiving the input image and the template image. The defect detection model performing an absolute image difference between the input image and the template image to identify defect locations at locations where differences are identified between the input image and the template image. The defect detection model generates an output image has defect identifiers overlaid on the input image at the identified defect locations, if any.

In a further embodiment, a part inspection method is provided and includes imaging a part using a vision device to generate an input image. The method analyzes the input image through a defect detection model of a part inspection system by compares the input image to a template image to identify defect locations. The method generates an output image by overlaying defect identifiers on the input image at the identified defect locations.

### BRIEF DESCRIPTION OF THE DRAWINGS

FIG. 1 illustrates a part inspection system in accordance with an exemplary embodiment.

FIG. 2A illustrates an input image of a “good” part (part without defects) in accordance with an exemplary embodiment.

FIG. 2B illustrates a comparison image of the “good” part in accordance with an exemplary embodiment.

FIG. 2C illustrates an output image of the “good” part in accordance with an exemplary embodiment.

FIG. 3A illustrates an input image of a “bad” part (part with defects) in accordance with an exemplary embodiment.

FIG. 3B illustrates a comparison image of the “bad” part in accordance with an exemplary embodiment.

FIG. 3C illustrates an output image of the “bad” part in accordance with an exemplary embodiment.

FIG. 4 is a flow chart of a part inspection method in accordance with an exemplary embodiment.

### DETAILED DESCRIPTION OF THE INVENTION

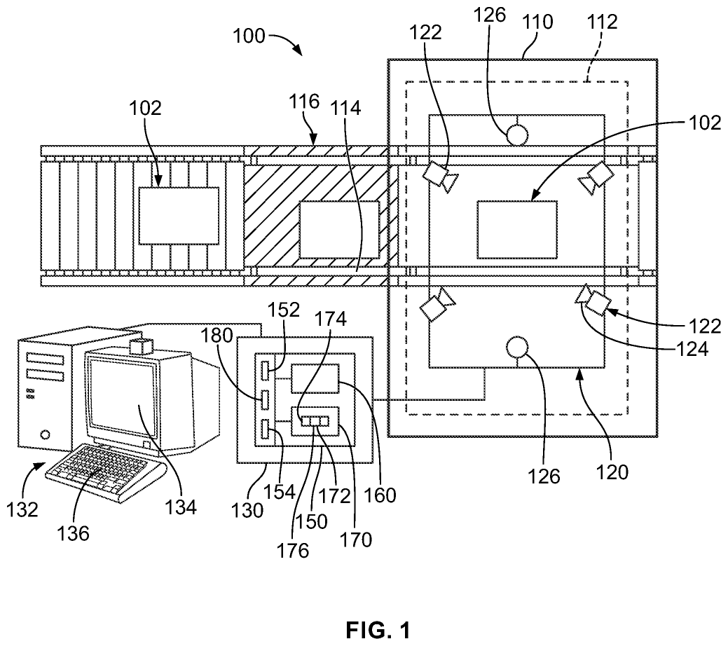

FIG. 1 illustrates a part inspection system 100 in accordance with an exemplary embodiment. The part inspection system 100 is used to inspect parts 102 for defects. In an exemplary embodiment, the part inspection system 100 is a vision inspection system using one or more processors to analyze digital images of the part 102 for defects. In an exemplary embodiment, the part inspection system 100 uses a generative neural network architecture for defect detection. The part inspection system 100 may be used to analyze the digital images for one particular type of defect or for multiple, different types of defects. In various embodiments, the part 102 may be an electrical contact, an electrical connector, a printed circuit board, or another type of electrical component. The part inspection system 100 may be used to inspect other types of parts in alternative embodiments.

The part inspection system 100 includes an inspection station 110. The inspection station 110 may be located downstream of a processing station (for example, a stamping machine, a drill press, a cutting machine, an assembly machine, and the like) to inspect the part 102 after processing. In other various embodiments, the inspection station 110 may be located at the processing station. The inspection station 110 includes an inspection zone 112.

In an exemplary embodiment, the inspection station 110 includes a locating feature 114 for locating the part 102 relative to the inspection zone 112. The locating feature 114 may be a table or other support platform used to hold and support the part 102 in the inspection station 110. The locating feature 114 may include one or more walls or other features forming datum surfaces for locating the part 102. The locating feature 114 may include a clamp or bracket holding the part 102. During use, the part 102 is presented at the inspection zone 112 for inspection. For example, the part 102 may abut against the locating feature 114 to locate the part 102 at the inspection zone 112. The part 102 may be moved within the inspection zone 112 by the locating feature 114.

In an exemplary embodiment, the inspection station 110 may include a manipulator 116 for moving the part 102 relative to the inspection station 110. For example, the manipulator 116 may include a conveyor or vibration tray for moving the part 102 through the inspection station 110. In other various embodiments, the manipulator 116 may include a feeder device, such as a feed finger used to advance the part 102, which is held on a carrier, such as a carrier strip. In other various embodiments, the manipulator 116 may include a multiaxis robot configured to move the part 102 in three-dimensional space within the inspection station 110. In alternative embodiments, the manipulator 116 may be an automated guided vehicle (AGV) configured to move the part 102 between various stations. In other alternative embodiments, the part 102 may be manually manipulated and positioned at the inspection zone 112 by hand.

The part inspection system 100 includes a vision device 120 for imaging the part 102 at the inspection zone 112. The vision device 120 may be mounted to a frame or other structure of the inspection station 110. The vision device 120 includes a camera 122 used to image the part 102. The camera 122 may be movable within the inspection zone 112 relative to the part 102 (or the part 102 may be movable relative to the camera 122) to change a working distance between the camera 122 and the part 102, which may affect the clarity of the image. Other types of vision devices 120 may be used in alternative embodiments, such as an infrared camera, or other type of camera that images at wavelengths other than the visible light spectrum.

In an exemplary embodiment, the part inspection system 100 includes a lens 124 at the camera 122 for controlling imaging. The lens 124 may be used to focus the field of view. The lens 124 may be adjusted to change a zoom level to change the field of view. The lens 124 is operated to adjust the clarity of the image, such as to achieve high quality images.

In an exemplary embodiment, the part inspection system 100 includes a lighting device 126 to control lighting conditions in the field of view of the vision device 120 at the inspection zone 112. The lighting device 126 may be adjusted to control properties of the lighting, such as brightness, light intensity, light color, and the like. The lighting affects the quality of the image generated by the vision device 120.

In an exemplary embodiment, the vision device 120 is operably coupled to a controller 130. The controller is operably coupled to the vision device 120 to control operation of the vision device 120. The controller 130 is operably coupled to a part inspection module 150 and receives one or more outputs from the part inspection module 150. The controller 130 includes or may be part of a computer in various embodiments. In an exemplary embodiment, the controller 130 includes a user interface 132 having a display 134 and a user input 136, such as a keyboard, a mouse, a keypad, or another type of user input.

In an exemplary embodiment, the controller 130 is operably coupled to the vision device 120 and controls operation of the vision device 120. For example, the controller 130 may cause the vision device 120 to take an image or retake an image. In various embodiments, the controller 130 may move the camera 122 to a different location, such as to image the part 102 from a different angle. In various embodiments, the controller 130 may be operably coupled to the manipulator 116 to control operation of the manipulator 116. For example, the controller 130 may cause the manipulator 116 to move the part 102 into or out of the inspection station 110. The controller 130 may cause the manipulator 116 to move the part 102 within the inspection station 110, such as to move the part 102 relative to the camera 122. The controller 130 may be operably coupled to the lens 124 to change the imaging properties of the vision device 120, such as the field of view, the focus point, the zoom level, the resolution of the image, and the like. The controller 130 may be operably coupled to the lighting device 126 to change the imaging properties of the vision device 120, such as the brightness, the intensity, the color or other lighting properties of the lighting device 126.

The part inspection station 110 includes a part inspection module 150 operably coupled to the controller 130. In various embodiments, the part inspection module 150 may be embedded in the controller 130 or the part inspection module 150 and the controller 130 may be integrated into a single computing device. The part inspection module 150 receives the digital image of the part 102 from the vision device 120. The part inspection module 150 analyzes the digital image and generates outputs based on the analysis. The output is used to indicate to the user whether or not the part has any defects. In an exemplary embodiment, the part inspection module 150 includes one or more memories 152 for storing executable instructions and one or more processors 154 configured to execute the executable instructions stored in the memory 152 to inspect the part 102.

In an exemplary embodiment, the part inspection module 150 includes a defect detection model 160 and an image morphing model 170. The controller 130 inputs the digital image to the defect detection model 160 for analysis. The defect detection model 160 processes the input image to determine if the part has any defects. In an exemplary embodiment, the defect detection model 160 includes a template image. The defect detection model 160 compares the input image to the template image to identify defects. For example, the defect detection model 160 performs image subtraction between the input image and the template image to identify defect locations. In an exemplary embodiment, the defect detection model 160 performs an absolute image difference between the input image and the template image to identify the defect locations. The defect locations may be stored and/or mapped to the input image. The defect locations may be output to another device to alert the operator. In an exemplary embodiment, the defect detection model 160 includes a template matching algorithm for matching the input image to the template image to identify the defect locations. The defect detection model 160 generates an output image and overlays defect identifiers on the output image at any identified defect locations. For example, the defect identifiers may be bounding boxes or other types of identifiers, such as highlighted areas. If no defects are detected, then the output image does not include any defect identifiers.

During processing of the image, the image morphing model 170 filters the data for defect identification. The image morphing model 170 may filter the data to remove noise for the output image. In an exemplary embodiment, the image morphing model 170 includes a low pass gaussian filter 172. The image morphing model 170 passes the absolute difference of images through the low pass gaussian filter 172 to filter the data. The image morphing model 170 may include other types of filters in alternative embodiments. Optionally, the image morphing model 170 includes a binary threshold filter 174 for filtering the data. The binary threshold filter may set all non-black pixels to white values such that the values are either black or white (binary results). The binary threshold filter 174 identifies the defect locations easily by identifying the white pixels versus the black pixels.

In an exemplary embodiment, the part inspection module 150 includes a generative neural network architecture 180 used to generate the template image from training images. The generative neural network architecture 180 needs only one class of images for training, which is compared to discriminative neural network architectures that require multiple classes of images for training. The training images used by the generative neural network architecture 180 are only images that do not include defects (known as “good” images). The generative neural network architecture 180 does not need images of parts that have defects (known as “bad” or “not good” images). The good images are easy to come by for training. The part may have many different types of defects or defects in many different areas but the generative neural network architecture 180 does not need to train the system for each type of defect or defect location. Rather, the generative neural network architecture 180 only uses the good images to train the system. The training may be accomplished quicker and easier with less operator training time. The processing time of the system may be reduced compared to systems that use discriminative neural networks. The template image created by the generative neural network architecture 180 for use by the part inspection module 150 is a good image free from defects. Such good image is compared to the actual input image by the defect detection model 160 to determine if any defects are present in the input image.

In an exemplary embodiment, the one or more of the memories 152 of the part inspection module 150 stores the generative neural network architecture 180. The generative neural network architecture 180 may be a VGG neural network having a plurality of convolutional layers, a plurality of pooling layers disposed after different convolutional layers, and an output layer. The one or more processors 154 associated of the part inspection module 150 are configured to analyze the digital image through the layers of the generative neural network architecture 180. In an exemplary embodiment, the generative neural network architecture 180 is stored as executable instructions in the memory 152. The processor 154 uses the generative neural network architecture 180 by executing the stored instructions. In an exemplary embodiment, the generative neural network architecture 180 is a machine learning artificial intelligence (AI) module.

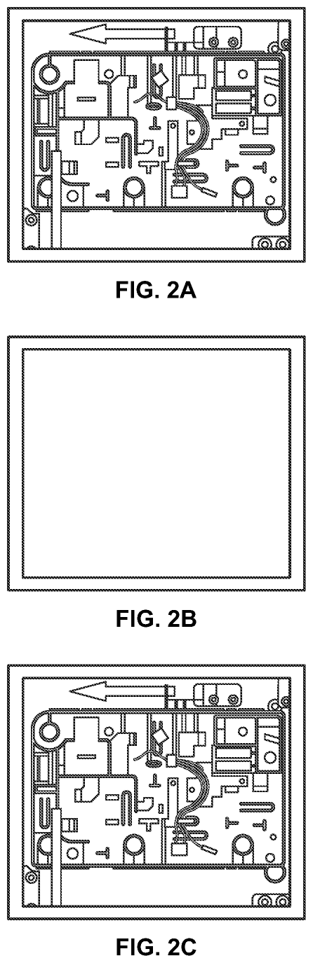

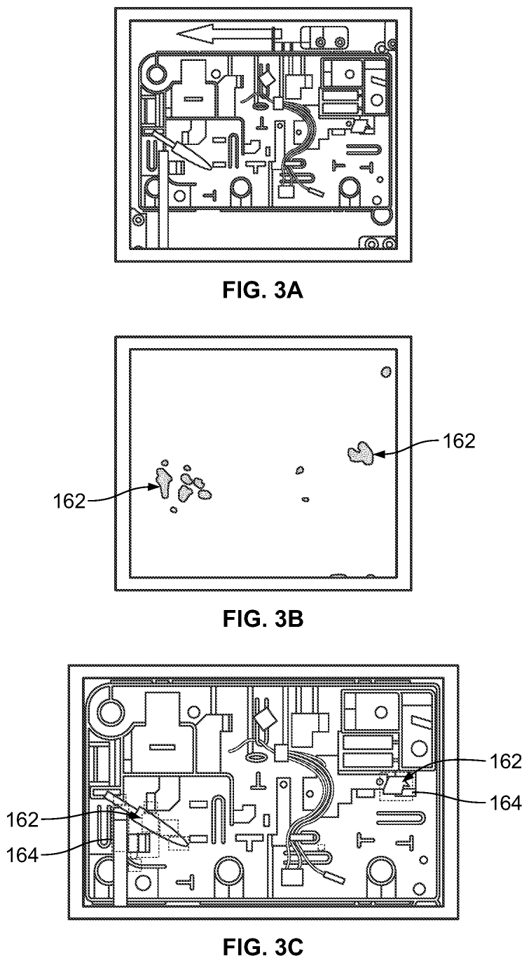

FIG. 2A illustrates an input image of a “good” part (part without defects); FIG. 2B illustrates a comparison image of the “good” part; FIG. 2C illustrates an output image of the “good” part. FIG. 3A illustrates an input image of a “bad” part (part with defects); FIG. 3B illustrates a comparison image of the “bad” part; FIG. 3C illustrates an output image of the “bad” part. FIGS. 2 and 3 are provided to illustrate comparisons of the good and bad images. In the illustrated embodiment, the part being imaged is a printed circuit board. The comparison images highlight differences in the image compared to a known image. If no defects are present, then no highlighted areas are shown in the image. For example, FIG. 2B does not show any highlighted areas because the image is a “good” image, whereas FIG. 3B does show highlighted areas because the image is a “bad” image.

The part inspection module 150 (shown in FIG. 1) analyzes the images for defect identification. The input images (FIGS. 2A and 3A) are generated by the vision device 120 and input to the part inspection module 150. During processing, the defect detection model 160 (shown in FIG. 1) of the part inspection module 150 compares the input image to the template image (for example, a “good” image generated by the training module). For example, the defect detection model 160 performs image subtraction between the input image and the template image to identify defect locations 162 (FIG. 3B). In an exemplary embodiment, the defect detection model 160 performs an absolute image difference between the input image and the template image to identify the defect locations. FIGS. 2B and 3B illustrate the comparison images. When comparing the good input image (FIG. 2A) to the template (good) image, there are no differences and thus the image subtraction yields no differences (no highlighted areas—compare with FIG. 3B). However, when comparing the bad input image (FIG. 3A) to the template (good) image, the image subtraction identifies the defect locations 162 (note there are no defect locations 162 on FIG. 2B of the “good” image). The defect detection model 160 then generates the output images (FIGS. 2C and 3C) and overlays defect identifiers 164 (FIG. 3C) on the output image at the identified defect locations. In the illustrated embodiment, the defect identifiers are bounding boxes surrounding the identified defect locations highlighting the areas having the defects to the operator on the displayed image. If no defects are detected, then the output image (FIG. 2C) does not include any defect identifiers. For example, if the input image is a good image, then the absolute difference between the input image and the output image would be no difference or zeroes, corresponding to black pixel values, through the entire image because the neural network is trained to a good image. However, if the input image is a bad image, then the absolute difference between the input image and the template image would be zeros everywhere except where the defects are located. The system detects and highlights the positions of the defects on the image with sufficient accuracy to notify the operator.

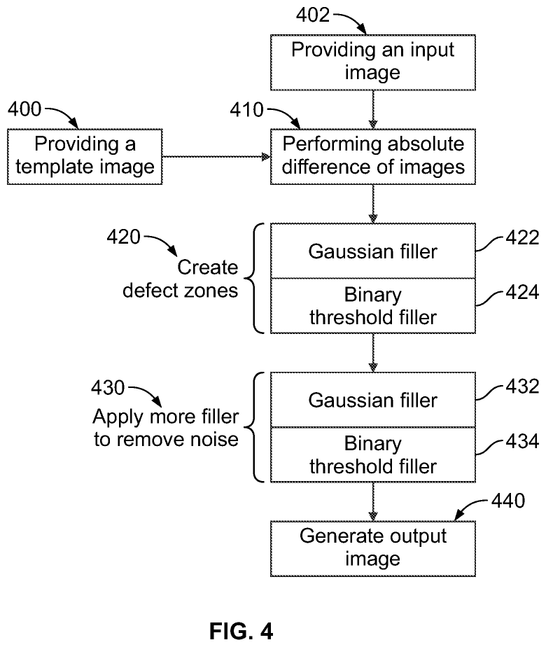

FIG. 4 is a flow chart of a part inspection method in accordance with an exemplary embodiment. The method includes providing 400 a template image and providing an input image 402. In an exemplary embodiment, the template image is provided by a generative neural network architecture based on a sufficient number of “good” images to train the part inspection system to an ideal good image. The input image is an image of the part being inspected. The input image is generated by the imaging device of the part inspection system.

The method includes performing 410 an absolute difference of images between the input image and the template image. The absolute image difference identifies the defect locations by comparing differences between the images. The absolute difference of images may be performed by performing an image subtraction of the pixel values to identify any appreciable difference in the pixel values, which correspond to a change between what is actually identified in the input image and what is expected in the ideal good image, which corresponds to a potential defect. If the pixel value difference is great enough or the area of pixel differences is large enough, then the difference corresponds to a defect. The absolute difference process may be performed by applying a template matching algorithm to segment the image. For example, the image may be segmented into a 256×256 pixel image. The image may be extracted into a 256×256×3 array.

In an exemplary embodiment, the method includes creating 420 defect zones in a comparison image. The defect zones are the areas, if any, of difference between the input image and the template image. The defect zones are the areas where the pixel value difference between the input image and the template image is great enough or large enough (for example, above a threshold), which corresponds to a defect. In an exemplary embodiment, the method includes passing 422 the data (for example, the pixel values) through a low pass gaussian filter to filter the data. In an exemplary embodiment, the method includes passing 424 the data (for example, the pixel values) through a binary threshold filter. The binary threshold filter may cause all pixel values above the threshold to one result (for example, black pixel value) and cause all pixel values below the threshold to a different result (for example, white pixel value) to identify the defect locations. In other embodiments, the binary threshold filter may cause all non-black pixels to white values. In other words, any difference is highlighted with white pixels and all non-differences are embedded with black pixels.

In an exemplary embodiment, the method includes applying 430 a noise filter to the data. In an exemplary embodiment, the method includes passing 432 the data through a low pass gaussian filter to filter the data. In an exemplary embodiment, the method includes passing 434 the data through a binary threshold filter. The filters remove noise from the data.

The method includes generating 440 an output image. The output image is used to indicate to the user whether or not the part has any defects. In an exemplary embodiment, the output image includes overlaid defect identifiers at any identified defect locations. The defect identifiers may be bounding boxes generally surrounding the area with the identified defect. If no defects are detected, then the output image does not include any defect identifiers.

During operation of the part inspection module 150, the part inspection module 150 runs programs to analyze the image. For example, the part inspection module 150 operates programs stored in the memory 152 on the processor 154. The processor 154 may include computer system executable instructions, such as program modules, being executed by a computer system. Generally, program modules may include routines, programs, objects, components, logic, data structures, and so on that perform particular tasks or implement particular abstract data types. The computing may be practiced in distributed cloud computing environments where tasks are performed by remote processing devices that are linked through a communications network. In a distributed cloud computing environment, program modules may be located in both local and remote computer system storage media including memory storage devices.

In an exemplary embodiment, various components may be communicatively coupled by a bus, such as the memory 152 and the processors 154. The bus represents one or more of any of several types of bus structures, including a memory bus or memory controller, a peripheral bus, an accelerated graphics port, and a processor or local bus using any of a variety of bus architectures.

The part inspection module 150 may include a variety of computer system readable media. Such media may be any available media that is accessible by the part inspection module 150, and it includes both volatile and non-volatile media, removable and non-removable media. The memory 152 can include computer system readable media in the form of volatile memory, such as random access memory (RAM) and/or cache memory. The part inspection module 150 may further include other removable/non-removable, volatile/non-volatile computer system storage media. By way of example only, a storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. The memory 152 may include at least one program product having a set (e.g., at least one) of program modules that are configured to carry out the functions of embodiments of the invention.

One or more programs may be stored in the memory 152, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the subject matter described herein.

The part inspection module 150 may also communicate with one or more external devices, such as through the controller 130. The external devices may include a keyboard, a pointing device, a display, and the like; one or more devices that enable a user to interact with system; and/or any devices (e.g., network card, modem, etc.) that enable the system to communicate with one or more other computing devices. Such communication can occur via Input/Output (I/O) interfaces. Still yet, part inspection module 150 can communicate with one or more networks such as a local area network (LAN), a general wide area network (WAN), and/or a public network (e.g., the Internet) via network adapter. Other hardware and/or software components could be used in conjunction with the system components shown herein. Examples, include, but are not limited to: microcode, device drivers, redundant processing units, and external disk drive arrays, RAID systems, tape drives, and data archival storage systems, etc.

The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 154, memory 152, and input/output interface can be interconnected, for example, via the bus as part of a data processing unit. Suitable interconnections, for example via bus, can also be provided to a network interface, such as a network card, which can be provided to interface with a computer network, and to a media interface, such as a diskette or CD-ROM drive, which can be provided to interface with suitable media.

Accordingly, computer software including instructions or code for performing the methodologies of the subject matter herein may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A part inspection system comprising:
a vision device configured to image a part being inspected and generate a digital image of the part;
a part inspection module communicatively coupled to the vision device and receiving the digital image of the part as an input image, the part inspection module including a defect detection model, the defect detection model including a template image, the defect detection model comparing the input image to the template image to identify defects, the defect detection model generating an output image, the defect detection model configured to overlay defect identifiers on the output image at the identified defect locations, if any.

2. The part inspection system of claim 1, wherein the defect detection model performs image subtraction to identify the defect locations.

3. The part inspection system of claim 1, wherein the defect detection model performs an absolute image difference between the input image and the template image to identify the defect locations.

4. The part inspection system of claim 1, wherein the defect detection model includes a template matching algorithm for matching the input image to the template image to identify the defect locations.

5. The part inspection system of claim 1, wherein the part inspection module includes a generative neural network architecture generating the template image from training images.

6. The part inspection system of claim 5, wherein the training images of the generative neural network architecture are only images that do not include defects.

7. The part inspection system of claim 1, wherein the defect identifiers are bounding boxes at the identified defect locations, if any.

8. The part inspection system of claim 1, wherein the output image does not include defect identifiers when the comparison of the input image and the template image do not identify any defect locations.

9. The part inspection system of claim 1, wherein the part inspection module includes an image morphing model having a low pass gaussian filter, the defect detection model comparing the input image and the template image to generate an absolute difference of images, the image morphing model applying the low pass gaussian filter to the absolute difference of images.

10. The part inspection system of claim 9, wherein the image morphing model includes a binary threshold filter setting all non-black pixels to white values to identify the defect locations.

11. A part inspection system comprising:
a vision device configured to image a part being inspected and generate a digital image of the part;
a part inspection module communicatively coupled to the vision device and receiving the digital image of the part as an input image, the part inspection module having a generative neural network architecture generating a template image from training images, the part inspection module including a defect detection model receiving the input image and the template image, the defect detection model performing an absolute image difference between the input image and the template image to identify defect locations at locations where differences are identified between the input image and the template image, the defect detection model generating an output image having defect identifiers overlaid on the input image at the identified defect locations, if any.

12. The part inspection system of claim 11, wherein the defect detection model performs image subtraction to identify the defect locations.

13. The part inspection system of claim 11, wherein the defect detection model includes a template matching algorithm for matching the input image to the template image to identify the defect locations.

14. The part inspection system of claim 11, wherein the training images of the generative neural network architecture are only images that do not include defects.

15. The part inspection system of claim 11, wherein the part inspection module includes an image morphing model having a low pass gaussian filter, the image morphing model applying the low pass gaussian filter to the absolute difference of images.

16. A part inspection method comprising:
imaging a part using a vision device to generate an input image;
analyzing the input image through a defect detection model of a part inspection system by comparing the input image to a template image to identify defect locations; and
generating an output image by overlaying defect identifiers on the input image at the identified defect locations.

17. The part inspection method of claim 16, wherein said analyzing comprises performing image subtraction between the input image and the template image to identify the defect locations.

18. The part inspection method of claim 16, wherein said analyzing comprises performing an absolute image difference between the input image and the template image to identify the defect locations.

19. The part inspection method of claim 18, further comprising applying a low pass gaussian filter to the absolute difference of images.

20. The part inspection method of claim 16, further comprising generating the template images using a generative neural network architecture analyzing only images that do not include defects.
